(19) United States
(12) Patent Application Publication
(10) Pub. No.: US 2004/0090859 A1
(43) Pub. Date: May 13, 2004

(54) Screw pump and multi screw extruder comprising a screw pump of this type

(76) Inventor: Gregor Chszaniecki, Hannover (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/469,944

(22) PCT Filed: Feb. 22, 2002
(86) PCT No.: PCT/DE02/00707

(30) Foreign Application Priority Data
Mar. 6, 2001 (DE) 101 12 028.1

(51) Int. Cl. B29B 7/48

(52) U.S. Cl. 366/85

(57) ABSTRACT

The invention relates to a screw pump comprising an inlet cross-section and an outlet cross-section for conveying free-flowing media, in particular plastic melts and rubber blends. Said pump comprises two screw shafts (20, 21), having a distance (α) between their axes, which are located in a pump housing (3) comprising two partially overlapping housing bores (4, 5) that run through said housing (3) in a longitudinal direction and which can be rotationally driven in an equidirectional manner. A plurality of single-flight screw element groups (1, 2), which closely intermesh, are arranged on said shafts in a rotationally-fixed manner. The invention also relates to a multi-screw extruder comprising a screw pump of this type.

### DESCRIPTION

The invention relates to a screw pump having an inlet cross section and an outlet cross section for delivering flowing media, in particular for delivering plastic melts and rubber mixtures, and also to a multiscrew extruder with a booster zone.

EP 0564884 A1 discloses a double screw extruder having two screw shafts, which are driven in the same direction and are fitted with various screw elements in the axial direction in order to form different extruder sections, and having a booster zone in the form of gear pump. The gears of the gear pump are in this case mounted on the screw shafts. One gear is firmly connected to the screw shaft so as to rotate with it, while the other gear can be rotated relatively on the other screw shaft. The two axial ends of the gears are covered by sealing plates which, together with the extruder cylinder, form a pump housing. An inlet opening and an outlet opening, respectively, are in each case made in the sealing plates in order to ensure the material flow. With this booster zone in the form of a gear pump, the disadvantage of double screw extruders driven in the same direction is eliminated, said disadvantage to be seen in the fact that this unit is only poorly suitable to build up an adequate extrusion pressure. Without a special melt pump, an extraordinary large extruder length would be necessary for the production of an adequate extrusion pressure. One disadvantage of this known solution is to be seen in the fact that only one of the two gears of the gear pump can be driven by a motor. In addition, the end sealing wall of the pump housing constitutes a hindrance to flow, at which volume elements of the material to be delivered can dwell for an uncontrolled time until they are delivered onward by the gear pump.

DE 199 47 967 A1 discloses another double screw extruder, whose screw shafts are driven in the same direction and are fitted with different screw elements in order to form different extruder sections. This extruder has, inter alia, a mixing zone, in which kneading blocks, which consist of individual kneading disks, are fitted to both screw shafts. These kneading disks are in each case profiles which can be referred to as single-turn screw elements with zero pitch and which are designed as tightly meshing profiles, which are also referred to as Erdmenger profiles. They in each case have a web shaped like the outer case of a cylinder which extends over a mesh angle γ and whose radius, taking into account the technically necessary play, corresponds to the radius of the housing bore of the extruder. Diametrically opposite the web is a further part shaped like the outer case of a cylinder, which may be referred to as a screw land and extends over a land angle α in the peripheral direction. The radius of this part shaped like the outer case of a cylinder corresponds to the core diameter of the screw. As viewed in cross section through the screw shaft, both parts shaped like the outer case of a cylinder are connected to each other by flanks shaped like circular arcs which, in accordance with the theory of Erdmenger, ensure tight meshing with the screw element respectively arranged on the other screw shaft and interacting with the screw element being considered. The interacting screw elements on the two screw shafts form a unit referred to below as a pair of screw elements. It is a characteristic of the known screw extruder that the two screw elements of a pair in each case have a completely identical contour and are merely fixed to the two screw shafts in such a way that they are rotated by an angle in relation to each other. In the known extruder, these screw elements are used as squeezer units, which are intended to produce a particularly high shearing and stretching flow in the material to be treated. Within the housing bore, between the extruder housing and the respective pair of the kneading disks, which are designed with identical shape, a chamber volume is formed which is divided up into part chamber volumes during a complete revolution of the kneading disks and whose size increases from time to time, remains constant from time to time and decreases from time to time. The fact that the axial ends of the part chamber volumes are completely or largely covered by sealing disks, which are preferably likewise designed as tightly meshing kneading disks, means that extremely high shearing and stretching flows are enforced. The use of tightly meshing single-turned screw elements to produce a booster zone in a double screw extruder is not considered in DE 199 47 967 A1.

It is an object of the present invention to propose a novel pump having an inlet cross section and an outlet cross section for delivering any desired flowing media and also a multiscrew extruder with a novel booster zone.

This object is achieved by a screw pump having the features specified in patent claim 1 and by a multiscrew extruder having the features of patent claim 11. Advantageous developments of the screw pump according to the invention emerge from patent claims 2 to 10.

The screw pump according to the invention has an inlet cross section and an outlet cross section for the flowing medium to be delivered which, in particular, can be formed of plastic melts or rubber mixtures. In principle, however, other media can also be delivered. The screw pump has at least two screw shafts, which are arranged in a pump housing in at least two housing bores which partly overlap and pass through the pump housing in the longitudinal direction. On all the screw shafts, which have an axial spacing a from the adjacent screw shaft arrangements and can be driven in rotation in the same direction, a large number of pairs of substantially tightly meshing screw elements are arranged firmly on said shafts so as to rotate with them. In axial cross section, as viewed from the longitudinal axis of the screw shaft, in each case the screw elements have a web shaped like the outer case of a cylinder, whose radius Rₐ corresponds to the radius of the housing bore and which extends over a mesh angle γ in the peripheral direction between two web edges. Furthermore, on the sides diametrically opposite the web, the screw elements in each case have a further part shaped like the outer case of a cylinder, which is referred to as a land and whose radius Rᵢ corresponds to the difference between the axial spacing a and the radius Rₐ and which extends over a land angle α in the peripheral direction. The land and the web of a screw element are in each case connected to each other by flanks. These flanks are preferably formed in the manner of a circular arc, so that the result is close meshing over the entire periphery of the screw elements of an arrangement. As distinct from the kneading disks which, according to DE 199 47 967 A1, are connected together to form squeezer blocks, the screw elements of an arrangement of intermeshing screw elements do not have the same shape. Instead, the invention provides for the intermeshing screw elements in each case to have mesh angles γ of different size. One screw element therefore has a large mesh angle γ₁, while the screw elements meshing with this have a small mesh angle γ₂. In this case, the screw elements on all the screw shafts are in each case arranged one behind another in such a way that in each case a screw element with the small mesh angle of an arrangement of intermeshing screw elements alternates with the large mesh angle of the immediately adjacent arrangement in the axial direction. Two screw elements lying axially closest to each other and each having the large mesh angle γ₁, between which in each case only one screw element with the small mesh angle γ₂ is located, are in each case arranged on the screw shaft, according to the invention, so as to be rotated through an offset angle ε in relation to each other such that, depending on the envisaged delivery direction, the left or right web edge of the one screw element with a large mesh angle γ₁ is located in the vicinity of the respective other (right or left) web edge of the other screw element, the webs of the two screw elements with the large mesh angle in each case being connected, in the region of the two web edges lying close to each other, by the web of the screw element with the small mesh angle arranged between them, so that in each case a screw thread with a discontinuous pitch is formed. By means of arranging a sufficiently large number of screw elements one behind another, in this way axial sealing is achieved between the inlet cross section and the outlet cross section, if the technically necessary play between the individual elements is neglected. Between the inlet and the outlet cross section, chambers which are sealed off volumetrically from one another are formed in the axial direction and in each case extend in the axial direction over a plurality of arrangements of intermeshing screw elements. Depending on the configuration of the screw elements, for example seven to ten arrangements of intermeshing screw elements arranged axially one behind another are sufficient. For the function of the screw pump, it is not absolutely necessary for the profiles of the screw elements of an arrangement to be meshed tightly over the entire periphery. For this reason, the connections between the land and the web of a screw element can be configured differently from the tightly meshing flank form shaped like a circular arc. The flanks can therefore also run further on the inside, that is to say closer to the longitudinal axis of the respective screw shaft. However, the tightly meshing flank form has the great advantage that such a screw pump is self cleaning.

It is advantageously to select the offset angle E such that the two web edges lying axially close to each other of the two screw elements with the large mesh angle γ₁ are in each case continued without an offset in another web edge of the screw element arranged between them and having the small mesh angle γ₂. As viewed in the direction of the web edges, in this case the two webs of the screw elements with the large mesh angle γ₁ overlap precisely by the width of the web of the screw element with the small mesh angle γ₂ arranged between them. However, this arrangement is in no way imperative. It is also possible for a greater or smaller overlap or even a negative overlap to be selected, in which a certain leakiness of the respective part chamber volume is deliberately accepted.

In principle, it is possible to assign each arrangement of the intermeshing screw elements a different shape of the screw elements. However, for production reasons, it is recommended to design the arrangement of the meshing screw elements to be identical to one another.

It is particularly advantageous to provide the screw elements in each case with a twist angle δ since, in this way, the known delivery mechanism of screw elements (wiping on the inner surface of the housing bore) can additionally be used. The twist angle δ is understood to mean the angle by which the two axial ends of the respective screw element are rotated in relation to one another about the longitudinal axis of the screw shaft. This results in the web edges not being oriented parallel to the longitudinal axis of the screw shaft, but running helically. The twist angle δ expediently lies in the range from 10° to 30°, preferably in the range from 20°-26°. As compared with untwisted screw elements (δ=0°), such twisted screw elements have a considerably better priming behavior with regard to the material to be delivered.

In an arrangement of meshing screw elements, the small mesh angle γ₂ is preferably less than 20°. In the case of screw elements without a twist angle, the small mesh angle γ₂ is 0° in the theoretical ideal case, that is to say that the left and the right web edges in each case fuse to form one edge, and the associated web has a width of zero. However, this is less useful for practical operation, since as a result of the web width which is no longer present, very much poorer sealing with respect to the cylinder housing takes place. Particularly expedient small angles γ₂ lie in the range from 5-15°.

The large mesh angle γ₁ is necessarily given when the small mesh angle γ₂ is defined, since the sum of the two mesh angles γ₁ and γ₂ follows the relationship:

γₜₒₜₐₗ=360°−4×arc cos (a/2Rₐ).

The individual screw elements can in each case be formed in one piece. In this case, it is recommended to design the screw elements in a manner known per se with splined toothing in the region of the screw axis, so that they form a grid for the adjustment of the respectively desired offset angle ε.

It is particularly advantageous to assemble the individual screw elements in each case from a plurality of disk-like elements with the same contour, in particular when the twist angle δ=0°. In this way, screw elements of any desired length in the axial direction may be produced form completely identical disk-like elements. The axial length of the screw elements, with a given diameter of the housing bores, is a direct measure of the size of the chamber volumes of the screw pump and, therefore, with a given screw speed, for its delivery performance. By means of different numbers of disk-like elements for assembling a screw element, it is therefore possible to ensure adaptation of the pump performance to the task respectively present. If the twist angle δ is greater than 0°, the grid dimension of the splined shaft should be matched to the twist angle in such a way that the web edges of the individual disks can be joined to one another in a straight line.

Within an arrangement of intermeshing screw elements, in order to produce axial play without the otherwise necessary aid of spacer disks, which would have to be set between the screw elements, it is advantageous to design said screw elements with a slightly different axial length. The axial length of the screw elements with the large mesh angle therefore differs from the axial length of the screw elements with the small mesh angle, in accordance with the desired play.

In principle, the screw pump according to the invention can be used as a separate unit for the delivery of any desired media. However, it is particularly advantageous to use the screw pump as a booster zone within a multiscrew extruder which has at least two screw shafts driven in the same direction and fitted with various screw elements in the axial direction in order to form different extruder sections. In this case, the screw shafts of the screw pump are in each case coupled directly to the screw shafts of the extruder or are part of these.

In the following text, the present invention will be explained in more detail using exemplary embodiments which are illustrated in the figures, in which:

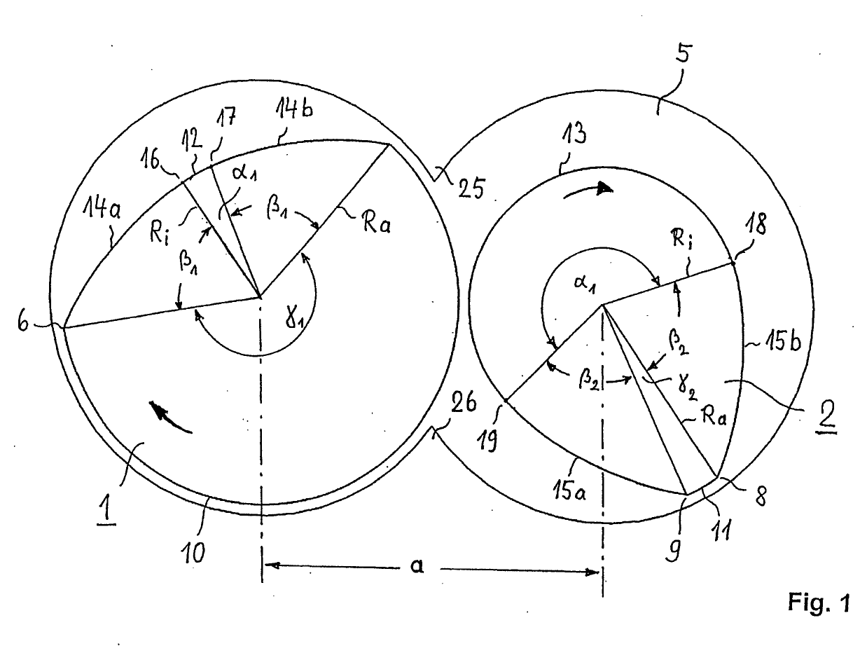

FIG. 1 shows a schematic view of a cross section through a screw pump according to the invention,

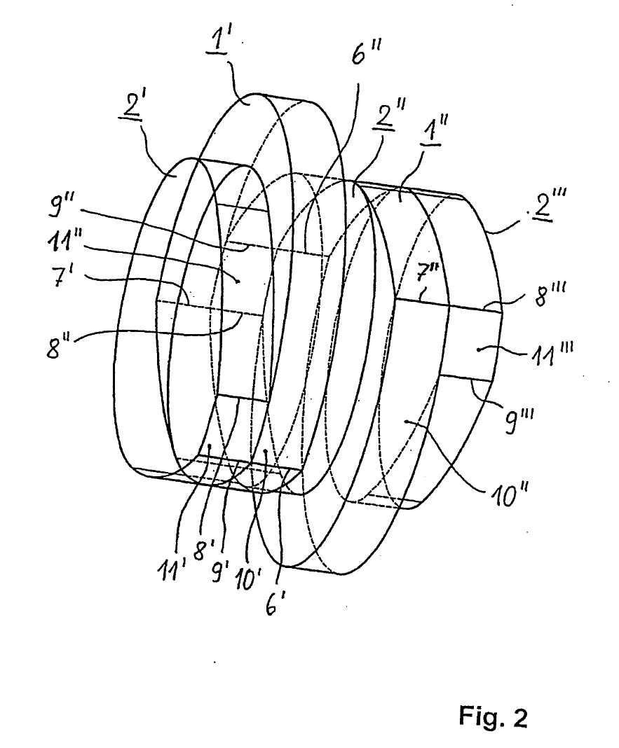

FIG. 2 shows a perspective wire model of a screw shaft having four screw elements,

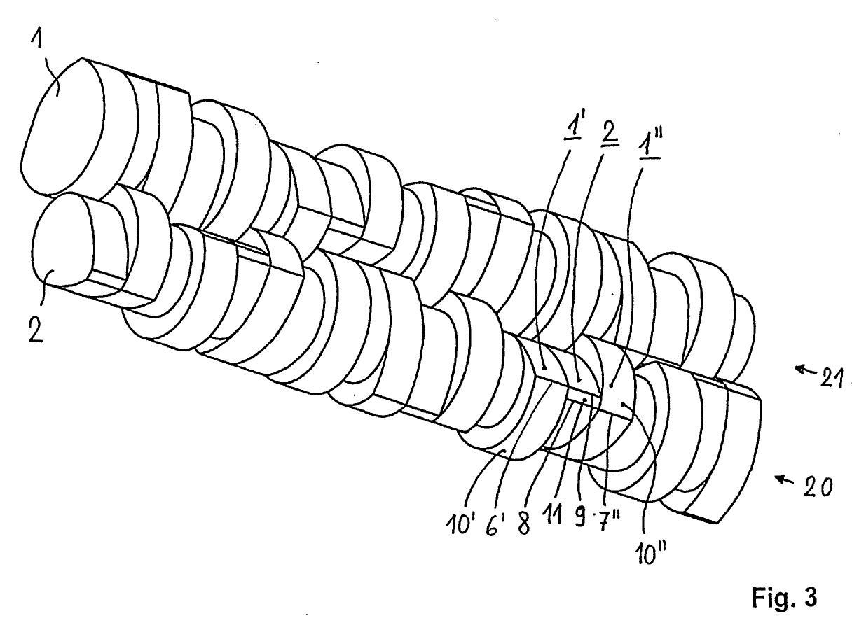

FIG. 3 shows a perspective view of the two screw shafts of a screw pump according to the invention without a twist angle,

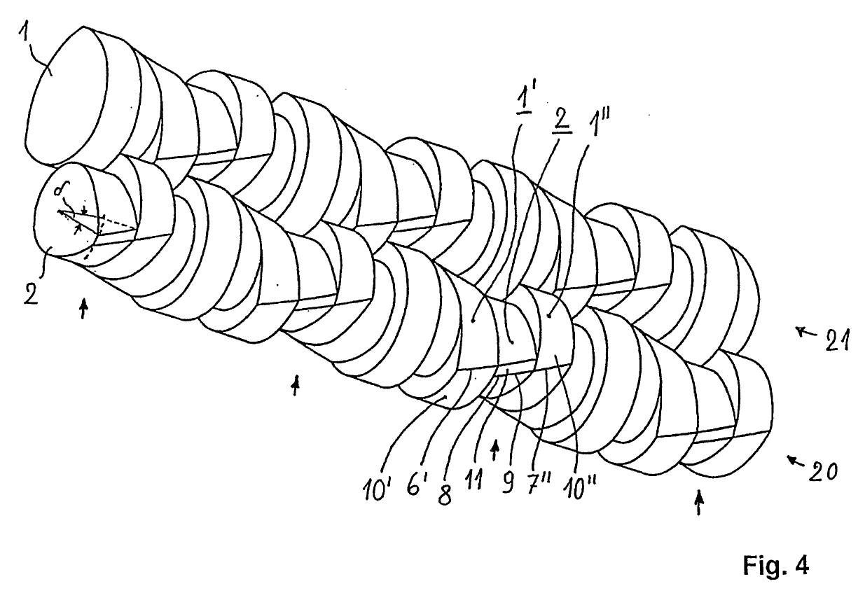

FIG. 4 shows a modification of FIG. 3 by the provision of a twist angle,

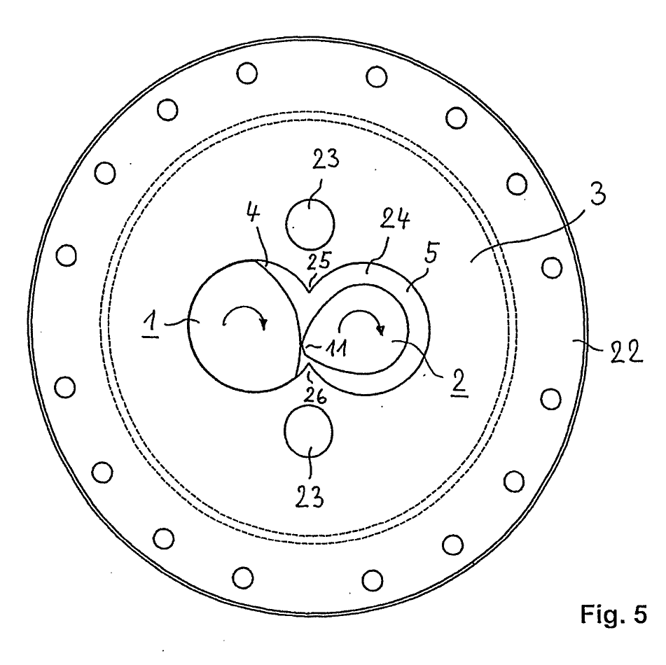

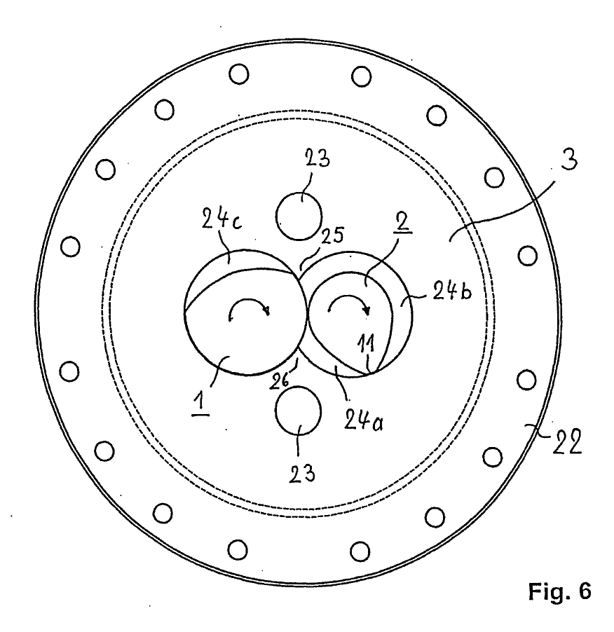

FIG. 5 and FIG. 6 show an end view of a screw pump according to the invention,

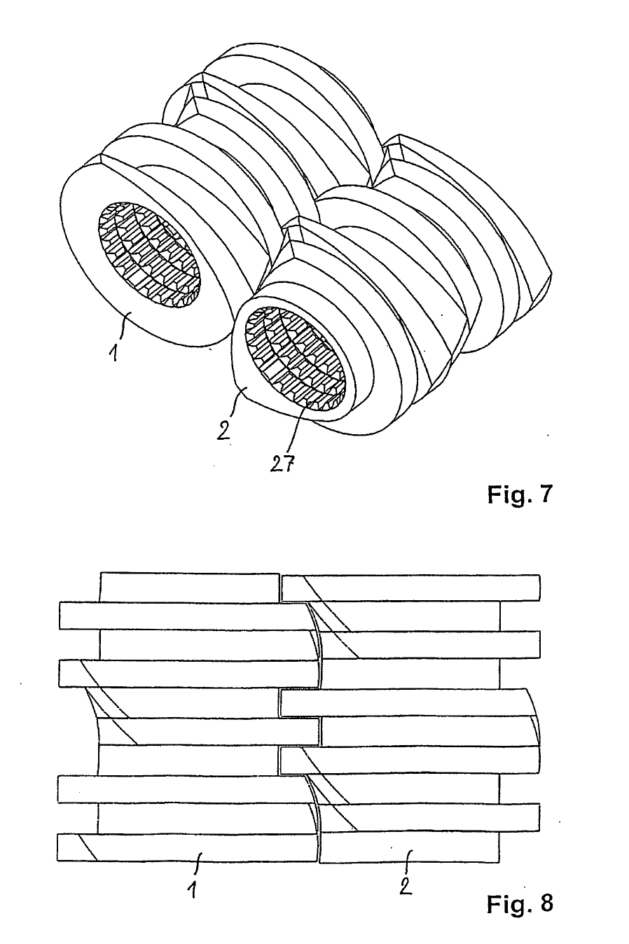

FIG. 7 shows a perspective view of screw elements according to the invention with splined toothing, and

FIG. 8 shows a plan view of the screw elements according to FIG. 7.

The schematic illustration in FIG. 1 shows a section through a screw pump according to the invention, which has a pair of screw elements 1, 2.

The screw elements 1, 2 are in each case arranged on screw shafts (not specifically illustrated) so as to rotate in the same direction in housing bores 4, 5, which partly overlap. The axial spacing of the screw shafts is designated by a. The screw element 1 has a web 10 shaped like the outer case of a cylinder, which can be seen in FIG. 1 as a circle with the radius Rₐ and extends over a mesh angle γ₁ in the peripheral direction. The radius Rₐ corresponds to the radius of the housing bore 4. The play between the screw element 1 and the wall of the housing bore 4 is shown in an exaggeratedly large form in FIG. 1, as is the play between the two screw elements 1, 2. The web 10 is bounded by the left web edge 6 and the right web edge 7. Diametrically opposite the web 10, a further part of the screw element 1 shaped like the outer case of a cylinder can be seen, which is referred to as the land 12 and has a radius Rᵢ corresponding to the radius of the screw core. The land 12 extends over a land angle α₁ between the two points 16 and 17. Between the web edge 6 and the point 16 and between the web 7 and the point 17, there run the two flanks 14a, 14b which each extend over a flank angle β₁ in the peripheral direction and which are in each case configured as circular arcs, whose center is arranged outside the longitudinal axis of the screw shaft. The size of this radius and the position of the associated center are given by the known relationships for tightly meshing screw profiles according to Erdmenger. The right screw element 2 is considerably different in terms of shape and size from the screw element 1, although the constructional configuration is similar. It has a web 11 shaped like the outer case of a cylinder and having the radius Rₐ, which extends over a mesh angle γ₂ between the two web edges 8 and 9. The mesh angle γ₂ is of the same size as the land angle α₁ of the screw element 1. Diametrically opposite the web 11 with the radius Rᵢ is a second part shaped like the outer case of a cylinder, which is referred to as the land 13 and extends over the land angle α₂ between the points 18 and 19. The land angle α₂ is of the same size as the mesh angle γ₁ of the screw element 1. In a corresponding way to that in the case of the screw element 1, the land 13 and the web 11 are connected to each other by flanks 15a, 15b shaped like circular arcs. The two flanks 15a, 15b in each case extend over a flank angle β₂, which is of the same size as the flank angle β₁ of the screw element 1. When the two screw elements 1, 2 rotate in the same direction, as indicated by the arrows shown, the two screw elements 1, 2 rub on each other, if no play is provided between the two in each case, during a complete revolution of the screw shafts, in such a way that the web 10 comes into sliding contact only with the land 13, the flank 14b comes into sliding contact only with the flank 15a, the land 12 comes into sliding contact only with the web 11, and the flank 14a comes into sliding contact only with the flank 15b. This provides the precondition for the self cleaning of the screw pump.

FIG. 2, which shows a section of a screw shaft assembled from five screw elements schematically in the form of a wire model, reveals in detail how the screw elements 1 with the large mesh angle and the screw elements 2 with the small mesh angle are arranged to be rotated in the relation to one another. The illustration shows three screw elements 2 with a small mesh angle which, to distinguish them, are designated as 2′, 2″ and 2′″. Arranged between them in each case is a screw element 1 with a large mesh angle which, in order to distinguish them, are designated by the reference symbols 1′, 1″. In a corresponding way, while maintaining the numbering with additional primes, the respectively associated web edges 6-9 and the webs 10, 11 are designated. The right web edge 9′ of the web 11′ of the left outer screw element 2′ is aligned coaxially with the left web edge 6′ of the screw element 1′ with the large mesh angle arranged immediately beside it. Since the two webs 11′ and 10′ have the same radius Rₐ, there is a smooth transition between them. If the web 10′ is followed from the right web edge 6′ as far as the left web edge 7′, then it can be seen that the latter is aligned coaxially with respect to the left web edge 8″ of the web 11″ of the second screw element 2″ with a small mesh angle. Therefore, a smooth transition from the web 10′ to the web 11″ is also provided between the screw element 1′ and the screw element 2″. The right web edge 9″ of the web 11″ is in turn aligned coaxially with the left web edge 6″ of the web 10″ of the second screw element 2″ with a large mesh angle. The right web edge 7″ of the web 10″ is in turn aligned coaxially with the left web edge 8′″ of a web 11′″ of a third screw element 2′″ with a small mesh angle. In this way, the screw shaft continues with any desired number of screw elements alternating between screw elements 1 with a large mesh angle and screw elements 2 with a small mesh angle.

This is shown by way of example in FIG. 3 for the two screw shafts 20, 21. In each case a total of ten screw elements 1 with a large mesh angle and ten screw elements 2 with a small mesh angle, that is to say a total of twenty screw elements, are arranged on each screw shaft 20, 21. The screw elements 1 with a large mesh angle are in each case rotated with respect to one another by an offset angle ε, not shown in FIG. 3, such that the coaxial alignment of the mutually associated web edges, described previously in relation to FIG. 2, is ensured.

FIG. 4 illustrates a modification of the arrangement of the two screw shafts 20, 21 from FIG. 3. This differs in that the individual screw elements 1, 2 are intrinsically twisted. The two axial ends of the screw elements 1, 2 are rotated in relation to each other by a twist angle δ about the longitudinal axis of the screw shaft 20, 21. As an example, the twist angle δ is indicated for the first screw element 2 with a small mesh angle arranged on the outside left. The two first screw elements 1, 2 shown on the outside left of the two screw shafts 20, 21 are in each case illustrated in the same angular position in the two FIGS. 3 and 4. It can be seen very clearly that, as a result of the twist angle δ, considerably differences in relation to the configuration according to FIG. 3 result over the length of the two screw shafts 20, 21 according to FIG. 4. While in FIG. 3 the angular position of two respectively immediately adjacently arranged screw elements 1, 2 is not repeated over the number of twenty pairs of the screw shafts, in the case of the screw shaft 20 in FIG. 4, as is made clear by the four vertical arrows shown, it is possible to see a fourfold repetition of the angle of position of the two first screw elements 1, 2; this is because each sixth screw element 1, 2 on a screw shaft 20, 21 again has this same angular position.

FIGS. 5 and 6 show, in each case in an end view, the screw pump according to the invention in different angular positions of the two first screw elements 1, 2. The pump housing 3, in which the housing bores 4, 5 are arranged, has a flange 22 which is provided with numerous through holes, with which the screw pump according to the invention can be inserted and mounted into a conventional double screw extruder as a housing section. The pump housing is provided with two pin bores 23 for the insertion of dowel pins. In the position illustrated in FIG. 5, a coherent chamber volume 24 has been formed within the two housing bores 4, 5 in the region of the two screw elements 1, 2. The chamber volume changes during the rotation of the screw elements 1, 2, initially not with respect to its size but merely with respect to its shape. This changes, however, as soon as the web 11 of the screw element 2 with the small mesh angle comes into sealing contact in the upper pocket area 25 of the pump housing 3 and moves further along the housing bore 5. This is because then three part chamber volumes 24a, 24b, 24c are produced from the one chamber volume 24, as emerges from the depiction of FIG. 6, illustrated in an advanced angular position. In the process, the part chamber volume 24c changes neither its volume nor its shape during a large part of the revolution. The material enclosed is merely displaced. By contrast, the part chamber volume 24 increases in size. Conversely, the part chamber volume 24a which lies close to the lower pocket area 26 of the pump housing 3 reduces in size with increasing clockwise rotation. This means that material is drawn into the part chamber volume 24b and material is forced out of the part chamber volume 24a. Since the screw pump according to the invention is sealed axially between the inlet cross section and the outlet cross section by means of the above-described chamber formation in the region of the individual screw elements, forcible volumetric delivery takes place within this screw pump. It is therefore possible, with such a pump, to effect a very effective build-up of pressure.

A further example of screw elements 1, 2 according to the invention with a twist angle>0° is illustrated in perspective form in FIG. 7. This is a total of 10 pairs which, in accordance with their envisaged mounting on a shaft core in each case (not illustrated), are lined up axially beside one another in a row and, in order to connect them firmly so that they rotate with the shaft core, each have splined toothing 27.

FIG. 8, which shows this arrangement in a plan view, reveals that the screw elements 1 with the large mesh angle are in each case produced to be slightly narrower than the screw elements 2 with the small mesh angle, in order to ensure the necessary axial play.

In a practical embodiment of the screw pump according to the invention, the following dimensions were used:

Rₐ=30 mm

Rᵢ=20.56 mm

γᵢ=α₂=219.84°

γ₂=α₁=9.84°

ε=120°

δ=15°.

In an alternative embodiment with a twist angle δ=0°, an offset angle of ε=150° was set. The axial length of the screw elements was in each case 20 mm.

It is particularly advantageous in this case that the elements of the two-shaft screw pump may be integrated in a very simple way in the screw shafts of a conventional double screw extruder having screw shafts driven in the same direction. As distinct from the integrated gear pump according to EP 0564884 A1, in this case both shafts of the pump are driven directly, so that high torsional strength is provided. The solution according to the invention is distinguished by a low multiplicity of parts and correspondingly low production costs. The functional reliability is extremely high and the outlay on maintenance virtually zero. As compared with pressure build-up zones with conventional screw elements, the result is drastically reduced axial lengths. Since the outlay on construction is comparatively low, it is readily possible for individual designs to be made to adapt the method optimally in special machines. The screw pump according to the invention may be retrofitted without difficulty in already existing machines.

List of reference symbols

| No. | Designation |
|---|---|
| 1 | Screw element with large mesh angle |
| 2 | Screw element with small mesh angle |
| 3 | Pump housing |
| 4 | Housing bore |
| 5 | Housing bore |
| 6 | Left web edge |
| 7 | Right web edge |
| 8 | Left web edge |
| 9 | Right web edge |
| 10 | Web |
| 11 | Web |
| 12 | Land |
| 13 | Land |
| 14a, 14b | Flank |
| 15a, 15b | Flank |
| 16-19 | Point between flank and land |
| 20 | Screw shaft |
| 21 | Screw shaft |
| 22 | Flange |
| 23 | Pin bore |
| 24 | Chamber volume |
| 24a-c | Part chamber volume |
| 25 | Upper pocket area |
| 26 | Lower pocket area |
| 27 | Splined toothing |
| α | Land angle |
| β | Flank angle |
| γ | Mesh angle |
| δ | Twist angle |
| ε | Offset angle |
| a | Axial spacing |

1. A screw pump having an inlet cross section and an outlet cross section for delivering flowing media, in particular plastic melts and rubber mixtures, having at least two screw shafts (20, 21) which are arranged with an axial spacing a in a pump housing (3), which has at least two partly overlapping housing bores (4, 5) which pass through the pump housing (3) in the longitudinal direction, which shafts can be driven in rotation in the same direction and on which a large number of arrangements of substantially closely intermeshing screw elements (1, 2) are arranged firmly so as to rotate with them, having the following features:
In axial cross section, as viewed from the longitudinal axis of the screw shaft (20, 21), in each case the screw elements (1, 2) have a web (10, 11) shaped like the outer case of a cylinder, whose radius Rₐ corresponds to the radius of the housing bore (4, 5) and which extends over a mesh angle γ in the peripheral direction between two web edges (6, 7; 8, 9).
On the side diametrically opposite the web (10, 11), the screw elements (1, 2) in each case have a land (12, 13) shaped like the outer case of a cylinder, whose radius Rᵢ corresponds to the difference between the axial spacing a and the radius Rₐ and which extends over a land angle a in the peripheral direction.
The land (12, 13) and the web (10, 11) of a screw element (1, 2) are in each case connected to each other by flanks (14a, 14b; 15a, 15b).
Within an arrangement of intermeshing screw elements, the screw elements (1, 2) in each case have different mesh angles γ (large mesh angle γ₁, small mesh angle γ₂) and are arranged axially one behind another on the screw shafts (20, 21) in such a way that on all the screw shafts (20, 21) in each case a screw element (2) with the small mesh angle γ₂ of an arrangement of intermeshing screw elements alternates with the screw element (1) with the large mesh angle γ₁ of the immediately adjacent arrangement.
Two screw elements (1′, 1″) lying axially closest to each other and each having the large mesh angle γ₁, between which in each case only one screw element with the small mesh angle γ₂ is located, are in each case arranged on the screw shaft (20, 21) so as to be rotated through an offset angle ε in relation to each other such that, depending on the envisaged delivery direction, the left (6′) or right web edge (7′) of the one screw element (1′) with the large mesh angle γ₁ is located in the vicinity of the respective other (right or left) web edge (7″ or 6″) of the other screw element (1″), and the webs (10′, 10″) of the screw elements (1′, 1″) with the large mesh angle γ₁ are in each case connected, in the region of the web edges (6′, 7″ or 7′, 6″) lying close to each other, by the web (11) of the screw element (2) with the small mesh angle γ₂ arranged between them, so that in each case a screw thread with a discontinuous pitch is formed.

2. The screw pump as claimed in claim 1, wherein the offset angle ε is selected such that the two web edges (6′, 7″ or 7′, 6″), lying close to each other, of the screw elements 1′, 1″ with the large mesh angle γ₁ are in each case continued without any offset in another web edge (8, 9) of the screw element (2) with the small mesh angle γ₂ arranged between them.

3. The screw pump as claimed in one of claims 1-2, wherein the arrangements of the intermeshing screw elements (1, 2) are the same as one another.

4. The screw pump as claimed in one of claims 1-3, wherein the screw elements (1, 2) in each case have a twist angle δ, by which the axial ends of the respective screw element (1, 2) are rotated in relation to one another about the longitudinal axis of the screw shaft (20, 21).

5. The screw pump as claimed in claim 4, wherein the twist angle δ lies in the range from 10° to 30°, in particular in the range from 20° to 26°.

6. The screw pump as claimed in one of claims 1-5, wherein the smaller mesh angle γ₂ in an arrangement of intermeshing screw elements (1, 2) is in each case less than 20°.

7. The screw pump as claimed in one of claims 1-6, wherein the screw elements (1, 2) are in each case formed in one piece.

8. The screw pump as claimed in one of claims 1-6, wherein the screw elements (1, 2) are in each case assembled from a plurality of disk-like elements with the same contour, in particular in the case of a twist angle δ=0°.

9. The screw pump as claimed in one of claims 1-8, wherein the flanks (14a, 14b; 15a, 15b) of the screw elements (1, 2) are designed in the shape of a circular arc.

10. The screw pump as claimed in one of claims 3-9, wherein in order to produce axial play, the screw elements (1) with the large mesh angle γ₁ are in each case designed with a slightly different axial length than the screw elements (2) with the small mesh angle γ₂.

11. A multiscrew extruder having at least two screw shafts which are driven in the same direction and which are fitted with various screw elements in the axial direction in order to form different extruder sections, and having a booster zone, wherein the booster zone is designed as a screw pump as claimed in one of claims 1-10, the screw shafts (20, 21) of the screw pump being coupled to the screw shafts of the extruder or being a part thereof.
